(19) United States
(12) Patent Application Publication
(10) Pub. No.: US 2006/0152413 A1
(43) Pub. Date: Jul. 13, 2006

(54) Antenna assembly

(76) Inventors: Hiroyuki Uno, Ishikawa-gun (JP); Yutaka Saito, Nomi-gun (JP); Genichiro Ota, Miura-shi (JP); Hiroshi Haruki, Yokohama-shi (JP)

Correspondence Address: STEVENS, DAVIS, MILLER & MOSHER, LLP, 1615 L. STREET N.W., SUITE 850, WASHINGTON, DC, 20036, US

(21) Appl. No.: 10/545,260

(22) PCT Filed: Jan. 16, 2004
(86) PCT No.: PCT/JP04/00290

§ 371 Date: Aug. 11, 2005

(30) Foreign Application Priority Data
Feb. 19, 2003 (JP) 2003-041492

(51) Int. Cl. H01Q 1/38

(52) U.S. Cl. 343/700 MS; 343/893; 343/876

(57) ABSTRACT

A dielectric substrate 101 is a square substrate having a dielectric constant εr, thickness t and length per side of Wd. A grounding conductor 102 is provided on one side of the dielectric substrate 101 in the same shape as the dielectric substrate 101. An MSA element 103 is formed of square copper foil having a length per side of Wp in the center of the other side of the dielectric substrate 101. Mono-pole antennas 104a to 104d are copper wires having a diameter D and length L and are spaced uniformly on diagonals of the MSA element 103 and disposed perpendicular to the dielectric substrate 101. The MSA element 103 or mono-pole antennas 104a to 104d is selectively fed, whichever has higher reception power. When the mono-pole antennas 104a to 104d are selected, the phases and amplitudes of the respective elements are controlled. This makes it possible to obtain a high gain in all directions over a hemisphere face from the horizontal direction to the vertical direction and provide an antenna apparatus in a small and simple configuration.

### TECHNICAL FIELD

The present invention relates to an antenna apparatus applicable to a microwave band and millimeter wave band, and is suitable for use in, for example, a fixed station apparatus in a wireless LAN system.

### BACKGROUND ART

A wireless LAN system connected to a communication terminal apparatus such as a notebook personal computer through a wireless channel is becoming widespread in recent years. The wireless LAN system is assigned a high frequency such as a 5 GHz band and 25 GHz band. For this reason, the characteristic of a radio wave moving rectilinearly becomes more pronounced and it is increasingly difficult to secure a transmission distance of the radio wave. Thus, in order for one fixed station apparatus to secure a wide area in which radio waves can be transmitted, an array antenna which forms directivities in arbitrary directions is designed. An invention disclosed in the Unexamined Japanese Patent Publication No. 2002-16427 is conventionally known as such an antenna apparatus.

FIG. 1A is a perspective view showing the configuration of a conventional array antenna apparatus and FIG. 1B is a cross-sectional view showing the configuration of the conventional array antenna apparatus. In these figures, a finite reflector 11 takes the shape of a circle having a diameter on the order of 1 wavelength of an operating frequency and is provided with a cylindrical conductive plate 14 around the perimeter thereof. A radiating element 12 has a length on the order of ½ wavelength and is provided vertically in the center of the top face of the finite reflector 11. A plurality of passive elements 13 are spaced uniformly around the radiating element 12, perpendicular to the top face of the finite reflector 11. Variable reactance elements 15 are connected to the passive elements 13 on the underside of the finite reflector 11.

In the antenna apparatus having such a configuration, it is possible to scan a principal beam in all directions within the horizontal plane by controlling the variable reactance elements 15 and changing the reactance value.

However, as the above described conventional technology suggests, the fixed station apparatus of the wireless LAN system may also be installed at substantially the same height as that of a communication terminal apparatus, but in this case, since there are many obstacles to radio waves, it is desirable to install it at a relatively high place such as a ceiling for indoor use. According to the above described conventional antenna apparatus, sufficient gains can be obtained in all directions of the horizontal direction, whereas sufficient gains cannot be obtained in the vertical direction and in directions tilted from the vertical direction. For this reason, when a conventional antenna apparatus is installed on, for example, the ceiling, there is a problem that it is difficult to maintain a good communication with a communication terminal apparatus which is located at a lower position.

### DISCLOSURE OF INVENTION

It is an object of the present invention to provide an antenna apparatus in a small and simple configuration capable of obtaining high gains in all directions over a hemisphere face covering from the horizontal direction to vertical direction.

The above described object can be attained by arranging a microstrip antenna element on the surface of a dielectric substrate, arranging a plurality of linear antenna elements radially on and perpendicular to the surface of the dielectric substrate, controlling the amplitude and phase of a signal for feeding the linear antenna elements on an element-by-element basis and selectively feeding the microstrip antenna element or the plurality of linear antenna elements.

### BRIEF DESCRIPTION OF DRAWINGS

FIG. 1A is a perspective view showing the configuration of a conventional array antenna apparatus;

FIG. 1B is a cross-sectional view showing the configuration of the conventional array antenna apparatus;

FIG. 2 is a perspective view showing the configuration of an antenna apparatus according to Embodiment 1 of the present invention;

FIG. 3 is a block diagram showing the configuration of the antenna apparatus according to Embodiment 1 of the present invention;

FIG. 4A illustrates a radiating pattern of the antenna apparatus according to Embodiment 1 of the present invention;

FIG. 4B illustrates a radiating pattern of the antenna apparatus according to Embodiment 1 of the present invention;

FIG. 4C illustrates a radiating pattern of the antenna apparatus according to Embodiment 1 of the present invention;

FIG. 5 illustrates a circular conical plane radiating pattern of a mono-pole array when cut with a circular conical plane at an angle of elevation θ of 65°;

FIG. 6 is a perspective view showing the configuration of an antenna apparatus according to Embodiment 2 of the present invention;

FIG. 7A illustrates a radiating pattern of the antenna apparatus according to Embodiment 2 of the present invention;

FIG. 7B illustrates a radiating pattern of the antenna apparatus according to Embodiment 2 of the present invention;

FIG. 7C illustrates a radiating pattern of the antenna apparatus according to Embodiment 2 of the present invention;

FIG. 8 illustrates a circular conical plane radiating pattern of a dipole array when cut with a circular conical plane at an angle of elevation θ of 65°;

FIG. 9 is a perspective view showing the configuration of an antenna apparatus according to Embodiment 3 of the present invention;

FIG. 10A illustrates a radiating pattern of the antenna apparatus according to Embodiment 3 of the present invention;

FIG. 10B illustrates a radiating pattern of the antenna apparatus according to Embodiment 3 of the present invention;

FIG. 10C illustrates a radiating pattern of the antenna apparatus according to Embodiment 3 of the present invention;

FIG. 11 illustrates a circular conical plane radiating pattern of a dipole array when cut with a circular conical plane at an angle of elevation θ of 60°;

FIG. 12 is a perspective view showing the configuration of an antenna apparatus according to Embodiment 4 of the present invention;

FIG. 13A illustrates a vertical plane radiating pattern at an azimuth angle φ=0° (X-Y plane);

FIG. 13B illustrates a vertical plane radiating pattern at an azimuth angle φ=45°;

FIG. 13C illustrates a vertical plane radiating pattern at an azimuth angle φ=90° (Y-Z plane);

FIG. 14 illustrates a circular conical plane radiating pattern of a microstrip array when cut with a circular conical plane at an angle of elevation θ of 25°; and

FIG. 15 illustrates a circular conical plane radiating pattern of a mono-pole array when cut with a circular conical plane at an angle of elevation θ of 70°.

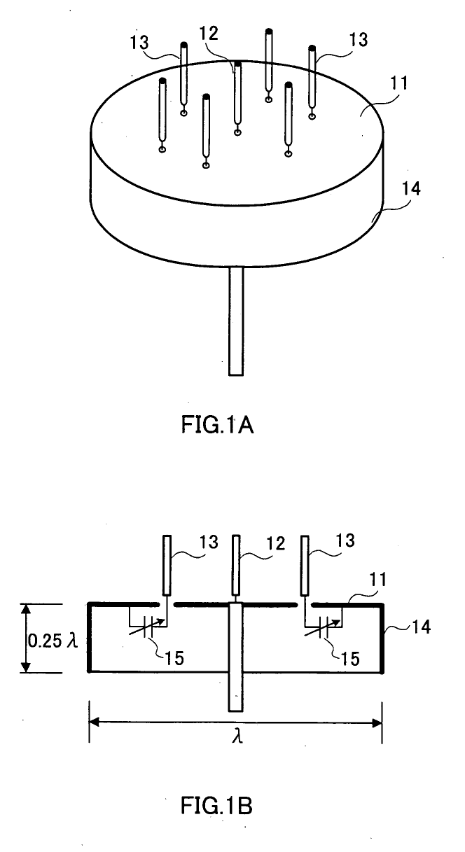

### BEST MODE FOR CARRYING OUT THE INVENTION

With reference now to the attached drawings, embodiments of the present invention will be explained below.

### Embodiment 1

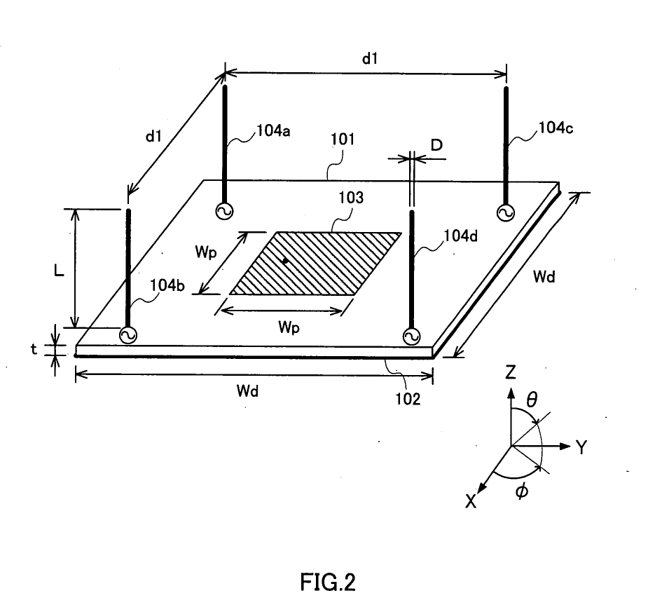

FIG. 2 is a perspective view showing the configuration of an antenna apparatus according to Embodiment 1 of the present invention. In this figure, a dielectric substrate 101 is a square substrate having a dielectric constant εr, thickness t and length per side Wd.

A grounding conductor 102 has the same shape as the dielectric substrate 101 and is provided on the plane in the −Z direction (see the coordinate system shown in FIG. 2) of the dielectric substrate 101.

A microstrip antenna element (hereinafter referred to as “MSA element”) 103 is formed in the center on the plane in the +Z direction of the dielectric substrate 101 as square copper foil having a length per side of Wp. A black bullet in the figure represents the position of a feeding point and is set at a position allowing impedance matching to a feeder.

Mono-pole antennas 104a to 104d are copper wires having a diameter D, length L, spaced uniformly (element distance d1) on the diagonals of the MSA element 103 and set perpendicular to the dielectric substrate 101. Hereinafter, the mono-pole antennas 104a to 104d may be collectively called a “mono-pole array.”

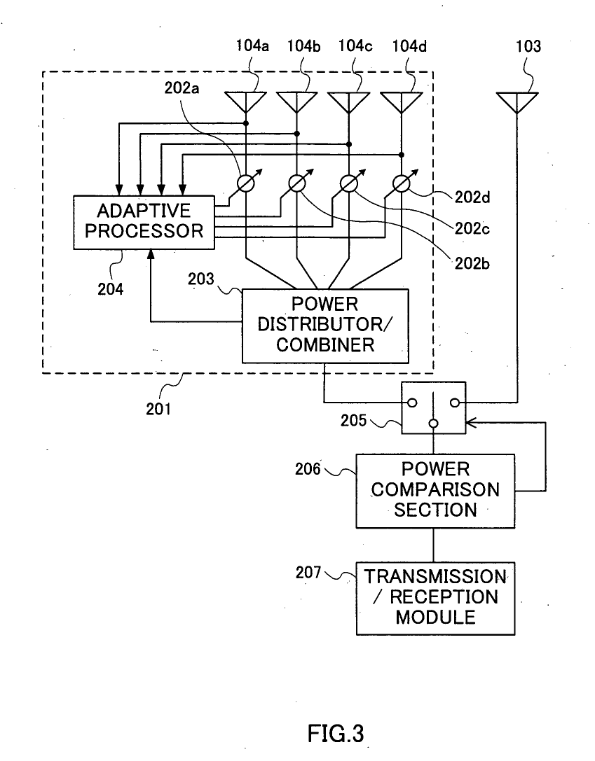

FIG. 3 is a block diagram showing the configuration of the antenna apparatus according to Embodiment 1 of the present invention. Parts in FIG. 3 common to those in FIG. 2 are assigned the same reference numerals as those in FIG. 2 and detailed explanations thereof will be omitted. In this figure, a mono-pole adaptive array 201 controls the phases and amplitudes of signals for feeding the mono-pole antennas 104a to 104d and controls a maximum radiating direction and null point direction.

Weight adjustors 202a to 202d are connected to the subsequent stage of the mono-pole antennas 104a to 104d respectively and assign weights to the phases and amplitudes of feeding signals based on the control by an adaptive processor 204.

A power distributor/combiner 203 combines power of signals input through the weight adjustors 202a to 202d, outputs the combined signal to the adaptive processor 204 and a power comparison section 206 and at the same time outputs to a transmission/reception module 207 through a high-frequency switch 205. Furthermore, the power distributor/combiner 203 distributes a signal output from the transmission/reception module 207 to the mono-pole antennas 104a to 104d.

The adaptive processor 204 controls the weight adjustors 202a to 202d based on signals received from the mono-pole array and signals output from the power distributor/combiner 203. More specifically, the adaptive processor 204 calculates the amplitudes and phases of signals received by the mono-pole array, measures power of signals output from the power distributor/combiner 203 and controls the weight adjustors 202a to 202d so that the power (level) of the signal output from the power distributor/combiner 203 becomes a maximum to thereby adjust the phases and amplitudes of the signals for feeding the mono-pole antennas 104a to 104d. Here, the weight adjustors 202a to 202d and adaptive processor 204 function as control sections.

The high-frequency switch 205 as a switchover section is, for example, a PIN diode or GaAs-FET (GaAs-Field Effect Transistor), etc., and connects an antenna which has received a signal having high power to the transmission/reception module based on the control of the power comparison section 206. That is, the high-frequency switch 205 selectively feeds either the mono-pole antennas 104a to 104d or the MSA element 103.

The power comparison section 206 as a comparison section measures the power of the signal output from the power distributor/combiner 203 and the power of the signal received by the MSA element 103 and controls the high-frequency switch 205 for operating the antenna which has received a signal with high power based on the result of a comparison to decide which power is higher.

The transmission/reception module 207 carries out predetermined reception processing such as A/D conversion and down-conversion and predetermined transmission processing such as D/A conversion and up-conversion.

Next, the operation of the antenna apparatus having the above described configuration will be explained. The power comparison section 206 compares the combined power of signals received by the mono-pole array and the power of the signal received by the MSA element 103 and controls the high-frequency switch 205 so as to connect the antenna with higher power to the transmission/reception module. Here, suppose the mono-pole array is selected as the operating antenna.

The adaptive processor 204 calculates the amplitudes and phases of the signals received by the mono-pole antennas 104a to 104d. The adaptive processor 204 also measures the combined power of the weight-adjusted received signal. In order to adjust the phases and amplitudes of signals received by the respective mono-pole antennas 104a to 104d so that the combined power becomes a maximum, the adaptive processor 204 controls the weight adjustors 202a to 202d. This makes it possible to change directivity on the horizontal plane (X-Y plane shown in FIG. 2) and direct the maximum radiating direction in an arbitrary direction.

When the power comparison section 206 selects the MSA element 103 as the operating antenna, the high-frequency switch 205 connects the MSA element 103 and transmission/reception module 207.

Thus, by selectively feeding the mono-pole array and MSA element 103 based on the reception power, it is possible to radiate stable radio waves. At the time of transmission, the antenna used for reception can be selected.

Next, the radiation characteristic when the operating frequency of the above described antenna apparatus is set as 5.2 GHz will be explained more specifically.

Here, parameters for configuring the antenna apparatus shown in FIG. 2 will be set as follows:
εr=2.6
t=1.5 [mm]
Wd=80 [mm] (approximately 1.4 wavelength)
Wp=15.5 [mm]
D=1 [mm]
L=29 [mm] (approximately 0.5 wavelength)
d1=29 [mm] (approximately 0.5 wavelength)

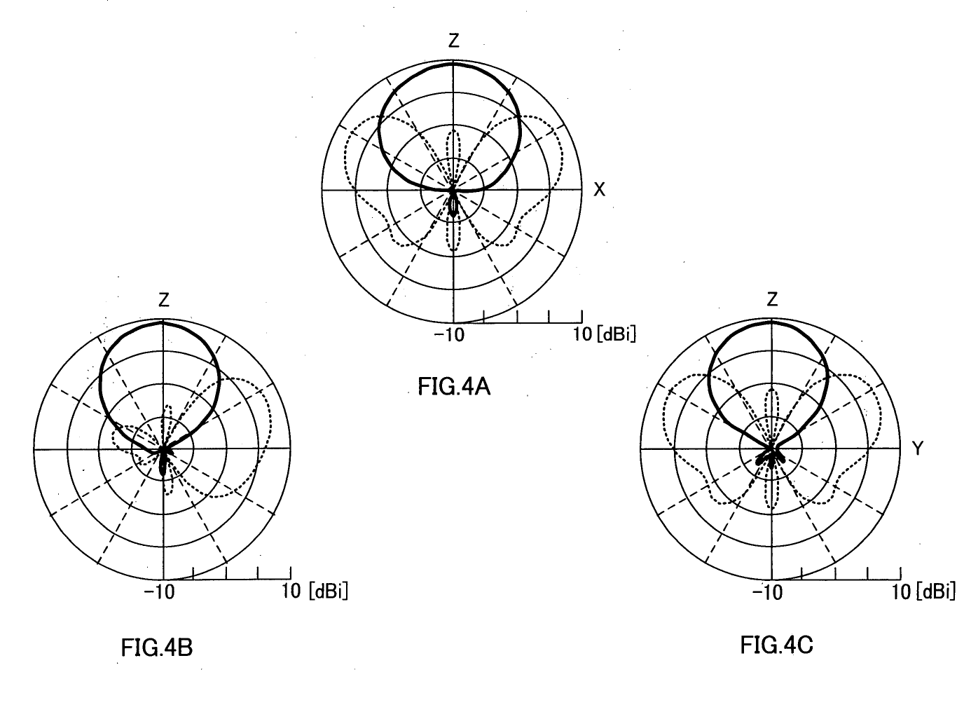

FIG. 4A to C illustrate radiating patterns of the antenna apparatus according to Embodiment 1 of the present invention. In FIG. 4A to C, solid lines represent radiating patterns of the MSA element 103 and dotted lines represent radiating patterns of the mono-pole array.

FIG. 4A is a vertical plane radiating pattern at an azimuth angle φ=0° (X-Z plane) with respect to the coordinate axis in FIG. 2. For the radiating pattern of the mono-pole array at this time, the phases of the mono-pole antennas 104a and 104c are set to 0° and the phases of the mono-pole antennas 104b and 104d are set to 180° so that the azimuth angle φ in the maximum radiating direction becomes 0°.

FIG. 4B is a vertical plane radiating pattern at an azimuth angle φ=45°. For the radiating pattern of the mono-pole array at this time, the phase of the mono-pole antenna 104a is set to 0°, the phases of the mono-pole antennas 104b and 104c are set to −127.3° and the phase of the mono-pole antenna 104d is set to 105.4° so that the azimuth angle φ in the maximum radiating direction becomes 45°.

FIG. 4C is a vertical plane radiating pattern at an azimuth angle φ=90° (Y-Z plane). For the radiating pattern of the mono-pole array at this time, the phases of the mono-pole antennas 104a and 104b are set to 0° and the phases of the mono-pole antennas 104c and 104d are set to 180° so that the azimuth angle φ in the maximum radiating direction becomes 90°.

As is evident from FIG. 4A to C, the maximum radiating direction of the MSA element 103 is a +Z direction and the maximum gain is 9.4 [dBi]. Furthermore, the angle of elevation θ in the maximum radiating direction of the mono-pole array is approximately 65° and the maximum gain is approximately 8 [dBi]. Furthermore, in the direction in which the angle of elevation θ is approximately 45°, both the gain of the MSA element 103 and the gain of the mono-pole array drop and become equal, but gains of 4 [dBi] or above are obtained.

When the azimuth angle φ in the maximum radiating direction of the mono-pole array is changed by adjusting the phases of the mono-pole antennas 104a to 104d, the vertical plane radiating pattern at φ=180° has a characteristic substantially equivalent to that in FIG. 4A and the vertical plane radiating patterns at φ=135°, 225°, 315° have characteristics substantially equivalent to that in FIG. 4B and the vertical plane radiating pattern at φ=270° has a characteristic substantially equivalent to that in FIG. 4C.

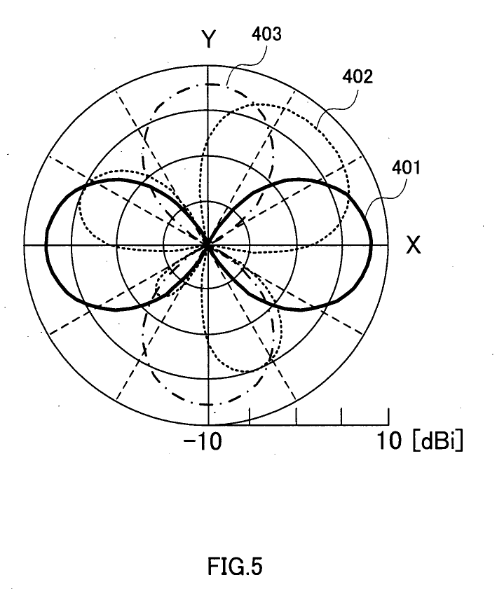

FIG. 5 illustrates a circular conical plane radiating pattern of a mono-pole array when cut with a circular conical plane at an angle of elevation θ of 65°. In this figure, solid lines 401 represent a circular conical plane radiating pattern of the mono-pole array in FIG. 4A, dotted lines 402 represent a circular conical plane radiating pattern of the mono-pole array in FIG. 4B and single-dot dashed lines 403 represent a circular conical plane radiating pattern of the mono-pole array in FIG. 4C.

As is evident from this figure, by changing the phases of the mono-pole antennas 104a to 104d, it is possible to direct the maximum radiating direction of the mono-pole array to all directions of the horizontal plane.

Having such a radiation characteristic, when the antenna apparatus having the above described configuration is attached to, for example, an indoor ceiling, the +Z direction corresponds to the floor direction and the −Z direction corresponds to the ceiling side. That is, when the directivity is preferred to be directed to the floor direction (high angle of elevation with an angle of elevation θ of 45° or less), the MSA element 103 is selected as the operating antenna. On the other hand, when the directivity is preferred to be directed to a low angle of elevation direction with an angle of elevation θ of 45° or above, the mono-pole array is selected as the operating antenna. Thus, by selecting and operating either the MSA element 103 or the mono-pole array, it is possible to obtain a sufficient gain of 4 [dBi] or above in all directions over the hemisphere face in the +Z direction. That is, the above described antenna apparatus is suitable for use in a fixed station apparatus installed in a higher place than a communication terminal apparatus.

Thus, according to this embodiment, a microstrip antenna is placed on the surface of a dielectric substrate, four mono-pole antennas are spaced uniformly around the microstrip antenna and perpendicular to the dielectric substrate plane to thereby form a mono-pole array, and the microstrip antenna and mono-pole array are selectively fed to realize an antenna apparatus which can obtain a high gain in all directions over the hemisphere face in the +Z direction. Furthermore, it is also possible to realize an antenna apparatus in a small and simple configuration.

### Embodiment 2

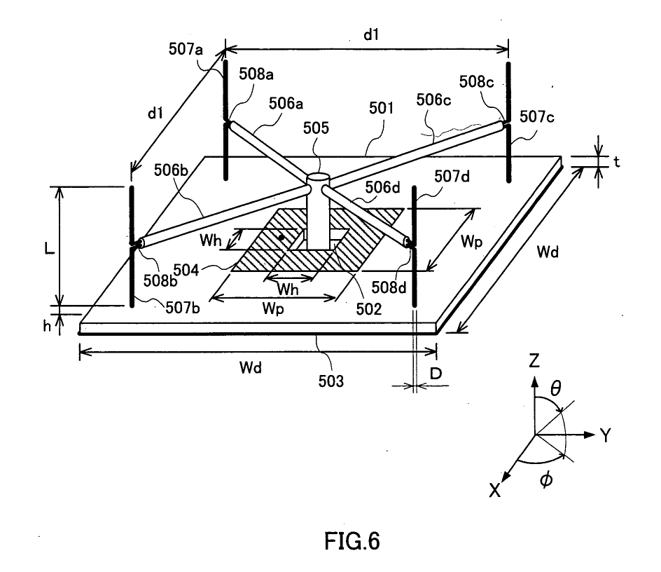

FIG. 6 is a perspective view showing the configuration of an antenna apparatus according to Embodiment 2 of the present invention. In this figure, a dielectric substrate 503 is a square substrate having a dielectric constant εr, thickness t and length per side of Wd and a square hollow section (hole) 502 having a length per side of Wh is formed in the center of the substrate.

A grounding conductor 503 has the same shape as the dielectric substrate 501 and is provided on the plane in the −Z direction of the dielectric substrate 501.

An MSA element 504 is formed of square copper foil having a length per side of Wp and the center of the copper foil is punched out in the same shape as the hollow section 502. The MSA element 504 is placed on the surface of the dielectric substrate 501 in the +Z direction in the punched out section aligned with the hollow section 502. A black bullet in the figure represents the position of a feeding point and is set at a position allowing impedance matching to a feeder.

The base of a column 505 is fixed by the hollow section 502 and supporting members 506a to 506d are radially spliced together at a height of approximately L/2 from the base.

The supporting members 506a to 506d are provided parallel to the diagonals of the MSA element 504, tips of the supporting members 506a to 506d are located at the vertices of a square having a length per side of d1 and the dipole antenna 507a to 507d are supported by the tips of the supporting members 506a to 506d at their center. This makes it possible to even support antenna elements such as dipole antennas which cannot be directly placed on the dielectric substrate 501.

The dipole antennas 507a to 507d are copper wires having a diameter D and length L and arranged at a distance of h from the dielectric substrate 501 and perpendicular to the dielectric substrate 501.

Feeder paths 508a to 508d are provided inside the column 505 and supporting members 506a to 506d to feed the dipole antennas 507a to 507d at the tips of the supporting members 506a to 506d.

The column 505 and supporting members 506a to 506d, even when made of metal, have little influence on the operation of the antenna apparatus, but they are preferably made of resin so as not to have the least influence on the operation of the antenna apparatus.

In this embodiment as well as Embodiment 1, the operating antenna is also selected based on a comparison between the power of a signal received by the MSA element 504 and the power of signals received by the dipole array.

Next, the radiation characteristic when the operating frequency of the above described antenna apparatus is set to 5.2 GHz will be explained more specifically.

Here, parameters configuring the antenna apparatus shown in FIG. 6 will be set as follows.
εr=2.6
t=1.5 [mm]
Wd=80 [mm] (approximately 1.4 wavelength)
Wp=15.5 [mm]
D=1 [mm]
L=29 [mm] (approximately 0.5 wavelength)
d1=29 [mm] (approximately 0.5 wavelength)
h=1 [mm]
Wh=8 [mm]

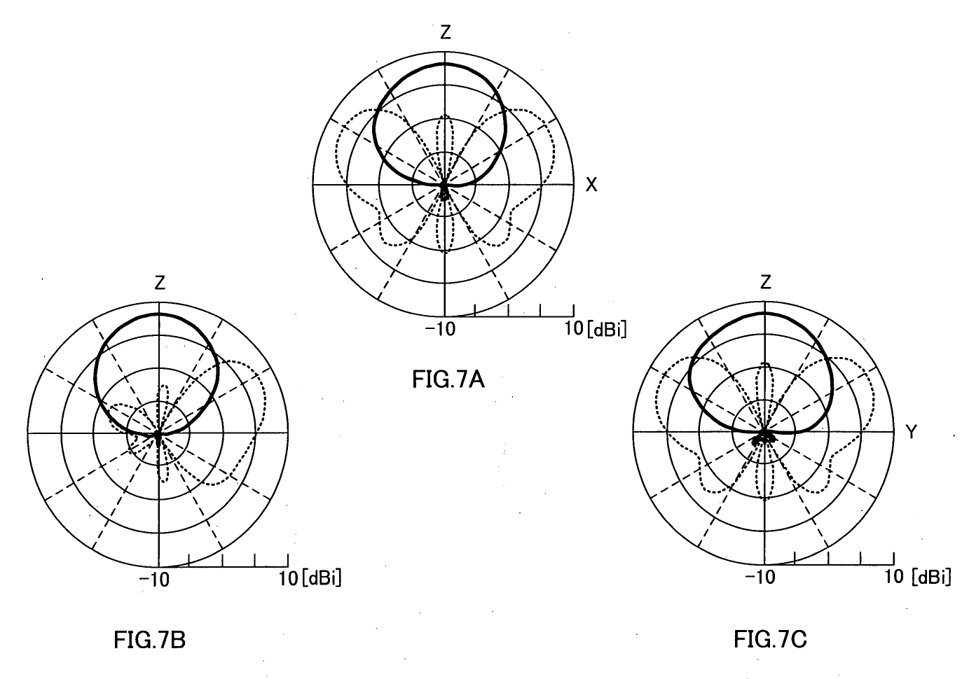

FIG. 7A to C illustrate radiating patterns of the antenna apparatus according to Embodiment 2 of the present invention. In FIG. 7A to C, solid lines represent radiating patterns of the MSA element 504 and dotted lines represent radiating patterns of the dipole array.

FIG. 7A is a vertical plane radiating pattern at an azimuth angle φ=0° (X-Z plane) with respect to the coordinate axis in FIG. 6. For the radiating pattern of the dipole array at this time, the phases of the dipole antennas 507a and 507c are set to 0° and the phases of the dipole antennas 507b and 507d are set to 180° so that the azimuth angle φ in the maximum radiating direction becomes 0°.

FIG. 7B is a vertical plane radiating pattern at an azimuth angle φ=45°. For the radiating pattern of the dipole array at this time, the phase of the dipole antenna 507a is set to 0° and the phases of the dipole antennas 507b and 507c are set to −127.3° and the phase of the dipole antenna 507d is set to 105.4° so that the azimuth angle θ in the maximum radiating direction of the dipole array becomes 45°.

FIG. 7C is a vertical plane radiating pattern at an azimuth angle φ=90° (Y-Z plane). For the radiating pattern of the dipole array at this time, the phases of the dipole antennas 507a and 507b are set to 0° and the phases of the dipole antennas 507c and 507d are set to 180° so that the azimuth angle φ in the maximum radiating direction of the dipole array becomes 90°.

As is evident from FIG. 7A to C, the maximum radiating direction of the MSA element 504 is the +Z direction and the maximum gain is 8.1 [dBi]. Furthermore, the angle of elevation θ in the maximum radiating direction of the dipole array is approximately 65° and the maximum gain is approximately 7.5 [dBi]. Furthermore, in the direction with the angle of elevation θ of approximately 45°, both the gain of the MSA element 504 and the gain of the dipole array drop and become equal, but gains of 4 [dBi] or above are obtained.

When the azimuth angle φ in the maximum radiating direction of the dipole array is changed by adjusting the phases of the dipole antennas 507a to 507d, the vertical plane radiating pattern at φ=180° has a characteristic substantially equivalent to that in FIG. 7A and the vertical plane radiating patterns at φ=135°, 225°, 315° have characteristics substantially equivalent to that in FIG. 7B and the vertical plane radiating pattern at φ=270° has a characteristic substantially equivalent to that in FIG. 7C.

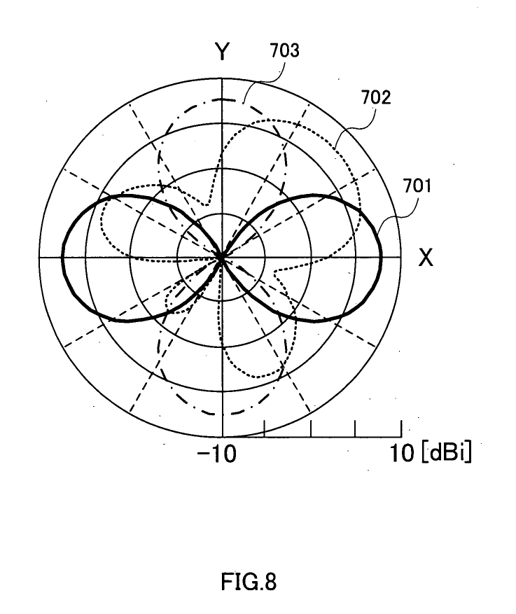

FIG. 8 illustrates a circular conical plane radiating pattern of a dipole array when cut with a circular conical plane at an angle of elevation θ of 65°. In this figure, solid lines 701 represent a circular conical plane radiating pattern of the dipole array in FIG. 7A, dotted lines 702 represent a circular conical plane radiating pattern of the dipole array in FIG. 7B and single-dot dashed line 703 represent a circular conical plane radiating pattern of the dipole array in FIG. 7C.

As is evident from this figure, by changing the phases of the dipole antennas 507a to 507d, it is possible to direct the maximum radiating direction of the dipole array to all directions of the horizontal plane.

Having such a radiation characteristic, when the directivity is preferred to be directed to a direction with a high angle of elevation θ of 45°0 or less, the MSA element 504 is selected as the operating antenna and when the directivity is preferred to be directed to a direction with a low angle of elevation θ of 45° or above, the dipole array is selected as the operating antenna. Thus, by selecting and operating either the MSA element 504 or the dipole array, it is possible to obtain a sufficient gain of 4 [dBi] or above in all directions over the hemisphere face in the +Z direction.

Thus, according to this embodiment, a microstrip antenna is placed on the surface of a dielectric substrate, four dipole antennas are spaced uniformly around the microstrip antenna and perpendicular to the surface of the dielectric substrate to thereby form a dipole array, and the microstrip antenna and dipole array are selectively fed to realize an antenna apparatus which can obtain a high gain in all directions over the hemisphere face in the +Z direction.

In this embodiment, a column is provided in the center of the dielectric substrate, supporting members are spliced with the column and dipole antennas are supported by the tips of the supporting members, but it is also possible to provide a plurality of columns around the dielectric substrate, splice the supporting members with the respective columns so that the supporting members support the dipole antennas

### Embodiment 3

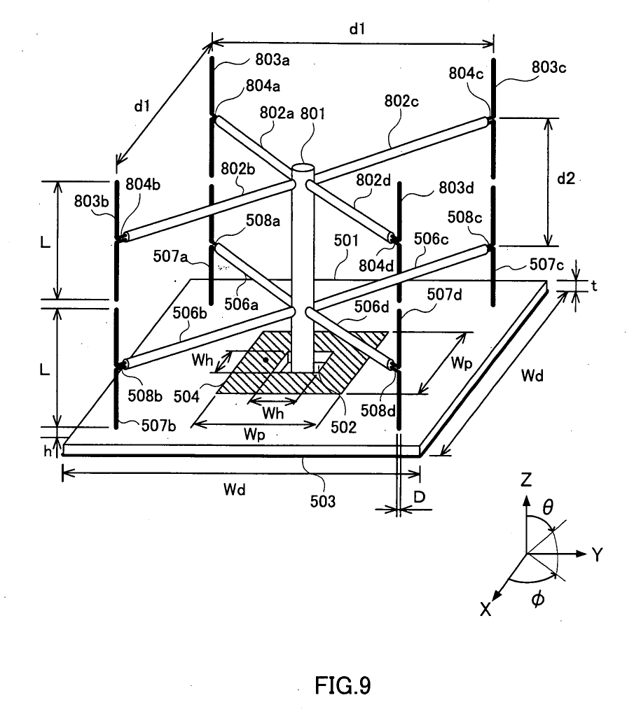

FIG. 9 is a perspective view showing the configuration of an antenna apparatus according to Embodiment 3 of the present invention. However, parts in FIG. 9 common to those in FIG. 6 are assigned the same reference numerals as those in FIG. 6 and detailed explanations thereof will be omitted. What FIG. 9 mainly differs from FIG. 6 is that the dipole array has a two-stage structure.

The base of a column 801 is fixed by a hollow section 502, supporting members 506a to 506d and supporting members 802a to 802d are radially spliced at heights on the order of L/2 and 3L/2 from the base respectively.

The supporting members 802a to 802d are placed at a distance d2 from the supporting members 506a to 506d in parallel thereto and the tips of the supporting members are located at vertices of a square having a length per side of d1 and the tips of the supporting members 802a to 802d support the dipole antennas 803a to 803d at their respective centers.

The dipole antennas 803a to 803d are made of copper wires having diameter D and length L and arranged on the extensions of dipole antennas 507a to 507d. That is, this antenna apparatus has a two-stage structure of dipole arrays each consisting of 4 elements. In this way, it is possible to control directivities adaptively on the vertical plane as well as the horizontal plane by adjusting the phase of each dipole antenna.

Hereinafter, the dipole antennas 507a to 507d closer to the dielectric substrate surface may be referred to as a first dipole array and the dipole antennas 803a to 803d farther from the dielectric substrate surface may be referred to as a second dipole array.

The feeder paths 804a to 804d are laid inside the column 801 and supporting members 802a to 802d and feed the dipole antennas 803a to 803d at the tips of the supporting members 802a to 802d.

In this embodiment as well as Embodiment 1, an operating antenna is selected based on a comparison between the power of a signal received by an MSA element 504 and the power of the signal received by the first and second dipole arrays.

Next, the radiation characteristic when the operating frequency of the antenna apparatus is set to 5.2 GHz will be explained more specifically.

Here, parameters constituting the antenna apparatus shown in FIG. 9 are set as follows.
εr=2.6
t=1.5 [mm]
Wd=80 [mm] (approximately 1.4 wavelength)
Wp=15.5 [mm]
D=1 [mm)
L=29 [mm] (approximately 0.5 wavelength)
d1=29 [mm] (approximately 0.5 wavelength)
d2=30 [mm] (approximately 0.5 wavelength)
h=1 [mm]
Wh=8 [mm]

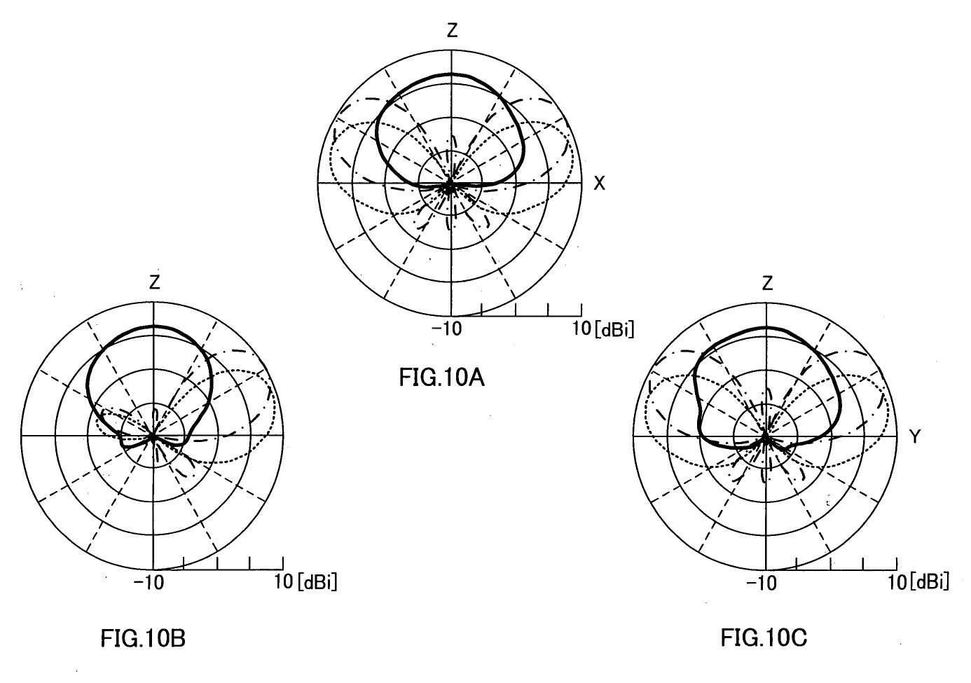

FIG. 10 illustrates radiating patterns of the antenna apparatus according to Embodiment 3 of the present invention. In FIG. 10A to C, solid lines represent a radiating pattern of the MSA element 504, dotted lines represent a radiating pattern when the phase of the first dipole array is 45° ahead of the phase of the second dipole array and single-dot dashed lines represent a radiating pattern when the phase of the first dipole array is 120° ahead of the phase of the second dipole array.

In FIG. 10A, the phase of the dipole array is adjusted so that the maximum radiating direction of the dipole array is directed to the direction with the azimuth angle φ of 0° on the coordinate axis in FIG. 9. Furthermore, the phase of the dipole array is adjusted so that the maximum radiating direction of the dipole array is directed to the direction with the azimuth angle φ of 45° in FIG. 10B and the direction with the azimuth angle φ of 90° in FIG. 10C respectively.

As is clear from FIG. 10A to C, the maximum radiating direction of the MSA element 504 is in the +Z direction and the maximum gain is 6.3 [dBi]. Furthermore, an angle of elevation θ in the maximum radiating direction of the dipole array can be changed within a range of 60° to 75° by providing a phase difference between the first dipole array and second dipole array and the maximum gain is 9 [dBi] or above.

Furthermore, in the direction with the angle of elevation θ of approximately 35°, both the gain when the phase of the first dipole array is 120° ahead of the phase of the second dipole array (single-dot dashed line shown in FIG. 10) and gain of the MSA element 504 drop and become the same, but a gain of approximately 4 [dBi] or above can be obtained.

When the azimuth angle φ in the maximum radiating direction of the dipole array is changed by adjusting the phases of the dipole antennas 507a to 507d and 803a to 803d, the vertical plane radiating pattern at φ=180° has a characteristic substantially equivalent to that in FIG. 10A, the vertical plane radiating patterns at φ=135°, 225°, 315° have characteristics substantially equivalent to those in FIG. 10B and the vertical plane radiating pattern at φ=270° has a characteristic substantially equivalent to that in FIG. 10C.

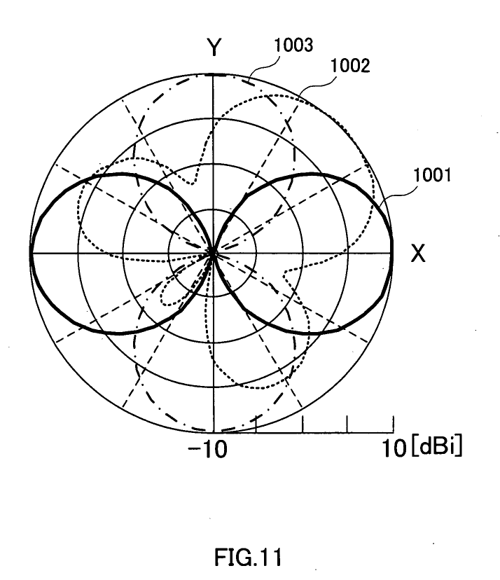

FIG. 11 illustrates a circular conical plane radiating pattern of the dipole array when cut with a circular conical plane at an angle of elevation θ of 60°. This figure shows a radiating pattern of the dipole array when the phase of the first dipole array is 120° ahead of the phase of the second dipole array. Solid lines 1001 represent a circular conical plane radiating pattern of the dipole array in FIG. 10A, dotted lines 1002 represent a circular conical plane radiating pattern of the dipole array in FIG. 10B and single-dot dashed lines 1003 represent a circular conical plane radiating pattern of the dipole array in FIG. 10C.

As is evident from this figure, adopting a two-stage structure of dipole arrays makes it possible to control directivity on a vertical plane at a low angle of elevation and increase the gain in a low angle of elevation direction.

Thus, this embodiment constructs a two-stage structure of dipole arrays from eight dipole antennas each stage consisting of four dipole antennas and selectively feeds the microstrip antenna and dipole arrays, and can thereby realize directivity control on the vertical plane at a low angle of elevation in addition to the effect of Embodiment 2 and increase the gain in a low angle of elevation direction.

### Embodiment 4

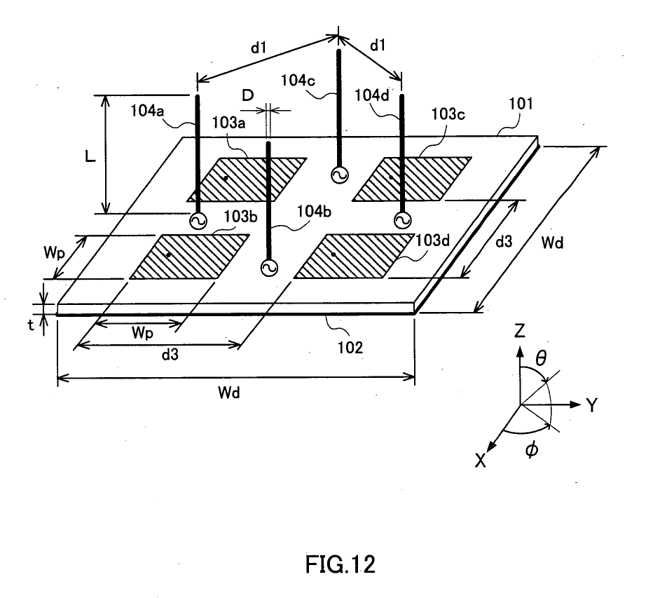

FIG. 12 is a perspective view showing the configuration of an antenna apparatus according to Embodiment 4 of the present invention. However, parts in FIG. 12 common to FIG. 2 are assigned the same reference numerals as those in FIG. 2 and detailed explanations thereof will be omitted.

MSA elements 103a to 103d are formed of square copper foil having a length per side of Wp on the surface of a dielectric substrate 101 in the +Z direction. The MSA elements 103a to 103d are spaced uniformly in the X direction and Y direction. At this time, the element distance of the MSA elements 103a to 103d is set to d3. The phases and amplitudes of signals of the MSA elements 103a to 103d are adjusted by an adaptive processor and weight adjustor (not shown) and directivities controlled. The MSA elements 103a to 103d hereinafter may also be referred to as a “microstrip array.”

The mono-pole antennas 104a to 104d are copper wires having a diameter D and length L and spaced uniformly (element distance d1) between the MSA elements and placed perpendicular to the dielectric substrate 101.

In this embodiment as well as Embodiment 1, an operating antenna is selected based on a comparison between the power of a signal received by a microstrip array and the power of a signal received by a mono-pole array.

Next, the radiation characteristic when the operating frequency of the antenna apparatus is set to 5.2 GHz will be explained more specifically.

Here, parameters constituting the antenna apparatus shown in FIG. 12 will be set as follows.
εr=2.6
t=1.5 [mm]
Wd=80 [mm] (approximately 1.4 wavelength)
Wp=15.5 [mm]
D=1 [mm]
L=29 [mm] (approximately 0.5 wavelength)
d1=29 [mm] (approximately 0.5 wavelength)
d3=29 [mm] (approximately 0.5 wavelength)

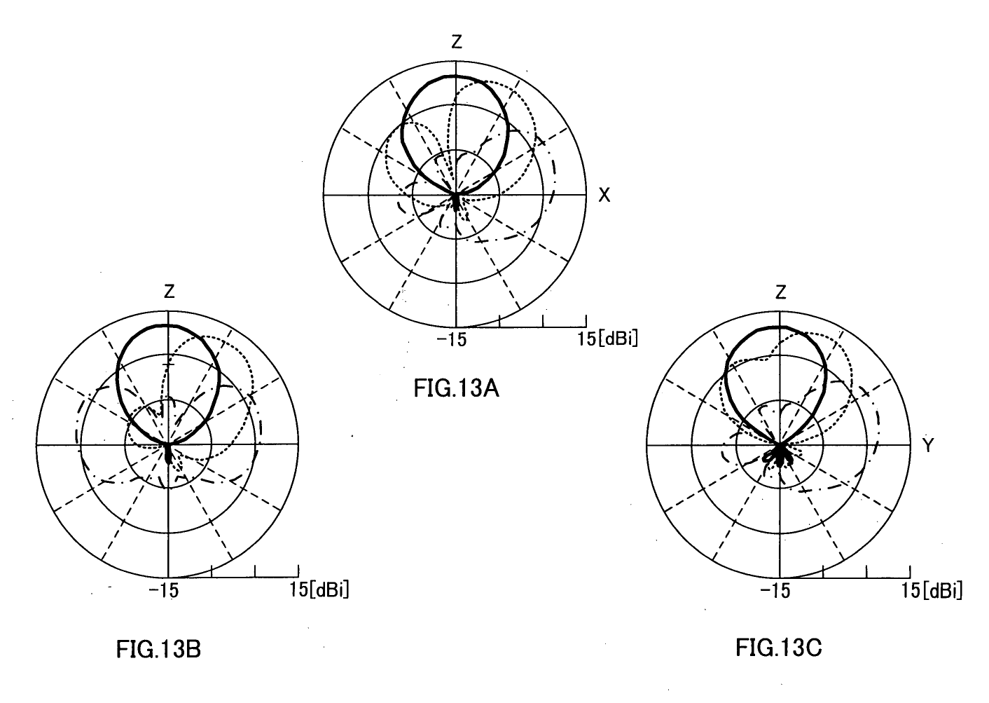

FIG. 13A to C illustrate radiating patterns of the antenna apparatus according to Embodiment 4. In FIG. 13A to C, solid lines represent a radiating pattern of the microstrip array when the MSA elements 103a to 103d are have the same phase, dotted lines represent a radiating pattern of the microstrip array when the phases of the MSA elements 103a to 103d are changed and single-dot dashed lines represent a radiating pattern of the mono-pole array.

FIG. 13A is a vertical plane radiating pattern at an azimuth angle φ=0° (X-Z plane) with respect to the coordinate axis in FIG. 12. The radiating pattern represented by dotted lines at this time shows the case where the phases of the MSA elements 103a and 103c are the same and 120° behind the phases of the MSA elements 103b and 103d. Furthermore, the radiating pattern of the mono-pole array represented by a single-dot dashed line shows the case where the phases of the mono-pole antennas 104a and 104d are set to 0°, the phase of the mono-pole antenna 104b is set to −127.3° and the phase of the mono-pole antenna 104c is set to 127.3°.

FIG. 13B shows a vertical plane radiating pattern at an azimuth angle φ=45°. The radiating pattern represented by a dotted line at this time shows the case where the phase of the MSA element 103a is set to 0°, the phases of the MSA elements 103b and 103c are set to −120° and the phase of the MSA element 103d is set to −240°. Furthermore, the radiating pattern of the mono-pole array represented by single-dot dashed lines shows the case where the phases of mono-pole antennas 104a and 104c are set to 0° and the phases of the mono-pole antennas 104b and 104d are set to 180°.

FIG. 13C shows a vertical plane radiating pattern at an azimuth angle φ=90° (Y-Z plane). The radiating pattern represented by a dotted line at this time shows the case where the phases of the MSA elements 103a and 103b are the same and 120° behind the phases of the MSA elements 103c and 103d. Furthermore, the radiating pattern of the mono-pole array represented by a single-dot dashed line shows the case where the phase of the mono-pole antenna 104a is set to 127°, the phases of the mono-pole antennas 104b and 104c are set to 0° and the phase of the mono-pole antenna 104d is set to −127.3°.

As is clear from FIG. 13, the angle of elevation θ of the maximum radiating direction of the microstrip array can be changed within a range of 0° to 25° by providing a phase difference between the MSA elements 103a to 103d and the maximum gain is 10 [dBi] or above. Furthermore, the angle of elevation θ in the maximum radiating direction of the mono-pole array is approximately 70° and the maximum gain is 7 [dBi] or above.

Furthermore, in the direction with the angle of elevation θ of approximately 55°, both the gain of the microstrip array and the gain of the mono-pole array drop and become the same, but gains of approximately 7 [dBi] or above can be obtained.

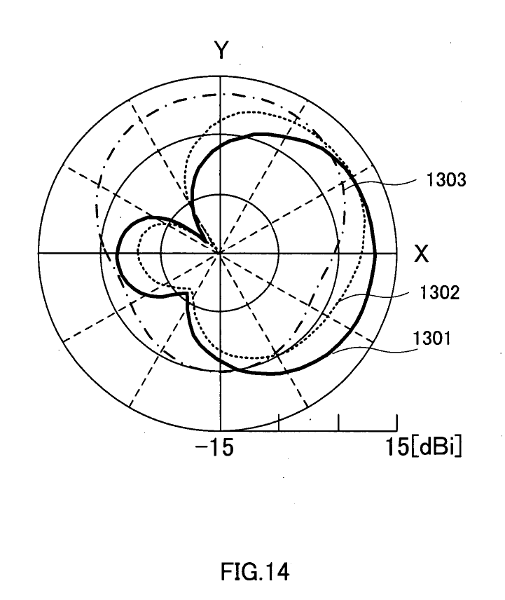

FIG. 14 illustrates a circular conical plane radiating pattern of the microstrip array when cut with a circular conical plane at an angle of elevation θ of 25°. In this figure, a solid line 1301 represents a circular conical plane radiating pattern of the microstrip array represented by the dotted line in FIG. 13A, a dotted line 1302 represents a circular conical plane radiating pattern of the microstrip array represented by the dotted line in FIG. 13B and a single-dot dashed line 1303 represents the circular conical plane radiating pattern of the microstrip array in FIG. 13C.

As is clear from this figure, it is possible to direct the maximum radiating direction of the microstrip array to all directions within the horizontal plane at a high angle of elevation θ of 25° by changing the phases of the MSA elements 103a to 103d.

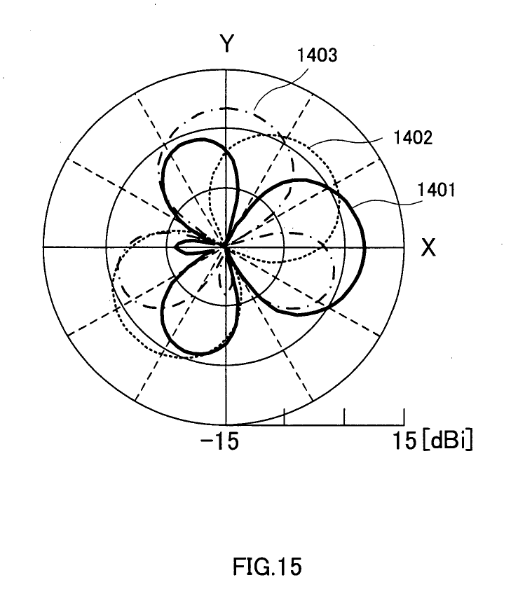

Furthermore, FIG. 15 illustrates a circular conical plane radiating pattern of the mono-pole array in FIG. 13 when cut with a circular conical plane at an angle of elevation θ of 70°. In this figure, a solid line 1401 represents the circular conical plane radiating pattern of the mono-pole array in FIG. 13A, a dotted line 1402 represents the circular conical plane radiating pattern of the mono-pole array in FIG. 13B and a single-dot dashed line 1403 represents the circular conical plane radiating pattern of the mono-pole array in FIG. 13C.

As is clear from this figure, it is possible to direct the maximum radiating direction of the mono-pole array to all directions within the horizontal plane by changing the phases of the mono-pole antennas 104a to 104d.

Having such a radiation characteristic, the MSA elements 103a to 103d are selected as the operating antennas when directivity is controlled in a high angle of elevation direction at an angle of elevation θ of 45° or less and the mono-pole antennas 104a to 104d are selected as the operating antennas when directivity is controlled in a low angle of elevation direction at an angle of elevation θ of 45° or above. Thus, it is possible to obtain a sufficient gain of 7 [dBi] or above in all directions over the hemisphere face in the +Z direction by selecting and operating either the microstrip array or mono-pole array.

Thus, this embodiment arranges a microstrip array made up of 4 elements and a mono-pole array made up of 4 elements on a dielectric substrate surface, selectively feeds the respective array antennas and controls the phases of the respective elements to be fed, and can thereby obtain a higher gain in all directions over a hemisphere face in the +Z direction and control directivity not only at a low angle of elevation but also at a high angle of elevation.

The above described embodiments have been explained assuming that the number of linear antenna elements is four (the number of antenna elements in each stage in the case of Embodiment 3), but the present invention is not limited to this and the number of linear antenna elements can be plural, not smaller than 3.

Furthermore, the above described embodiments have been explained assuming that the dielectric substrate and MSA element have a square shape, but the present invention is not limited to this. The linear antenna elements need not always be spaced uniformly on diagonals of the MSA element, either but can be arranged radially.

Furthermore, the parameters making up the antenna apparatus shown in the above described embodiments can be any parameters if they at least allow a predetermined radiation characteristic to be obtained according to the operating frequency band.

Furthermore, the above described embodiments can be implemented by modifying and combining the parameters making up the antenna apparatus as appropriate.

Furthermore, the above described embodiments selectively feed the linear antenna array and MSA elements (microstrip array) based on the power of signals received by the respective antennas, but the present invention can also be adapted so as to selectively feed them based on S/N ratios of the respective antennas and parameters indicating the reception state such as field intensity.

The antenna apparatus of the present invention adopts a configuration comprising a dielectric substrate having a predetermined dielectric constant, a microstrip antenna element placed on the surface of the dielectric substrate, a plurality of linear antenna elements arranged radially on and perpendicular to the surface of the dielectric substrate, a control section that controls the amplitudes and phases of signals for feeding the linear antenna elements on an element-by-element basis and a switchover section that selectively feeds the microstrip antenna element or the plurality of linear antenna elements.

According to this configuration, the plurality of linear antenna elements arranged perpendicular to the surface of the dielectric substrate are fed by signals whose amplitudes and phases are controlled, and it is thereby possible to direct a maximum radiating direction to an arbitrary direction horizontal to the surface of the dielectric substrate and the provision of the microstrip antenna element allows the radiating direction to be directed to the direction perpendicular to the surface of the dielectric substrate.

In the antenna apparatus of the present invention having the above described configuration, the switchover section comprises a comparison section that compares the reception state of the plurality of linear antenna elements and the reception state of the microstrip antenna element and the antenna element which has received a signal whose reception state is decided to be good by the comparison section is fed.

According to this configuration, of the microstrip antenna element and the plurality of linear antenna elements which have received signals, an antenna whose reception state is good is fed, and it is thereby possible to realize stable emission of radio waves.

The antenna apparatus according to the present invention in the above described configuration adopts a configuration comprising a hole provided in the center of the microstrip antenna element penetrating the microstrip antenna element and the dielectric substrate, a column provided in the hole and supporting members radially spliced from the column that support the linear antenna elements.

According to this configuration, it is possible to even support antenna elements such as dipole antennas which cannot be directly placed on the dielectric substrate.

In the antenna apparatus according to the present invention in the above described configuration, the plurality of linear antenna elements are arranged in multiple stages in the direction perpendicular to the surface of the dielectric substrate.

According to this configuration, by arranging the plurality of linear antenna elements in multiple stages and thereby providing a phase difference between the stages, it is possible to realize directivity control on the vertical plane at a low angle of elevation and increase the gain at in a low angle of elevation direction.

In the antenna apparatus according to the present invention in the above described configuration, a plurality of the microstrip antenna elements are arranged on the dielectric substrate and the control section controls the amplitudes and phases of signals for feeding the plurality of microstrip antenna elements on an element-by-element basis.

According to this configuration, it is possible to obtain a higher gain and control directivities at a high angle of elevation by feeding the plurality of linear antenna elements arranged on the surface of the dielectric substrate using signals whose amplitudes and phases are controlled.

The antenna apparatus according to the present invention in the above described configuration, mono-pole antennas or dipole antennas can be used as the plurality of linear antenna elements.

According to this configuration, whether mono-pole antennas or dipole antennas are used as the linear antenna elements, similar radiating patterns are obtained, and therefore it is possible to use any desired antennas.

As described above, the present invention arranges a microstrip antenna element on the surface of a dielectric substrate, arranges a plurality of linear antenna elements radially on and perpendicular to the surface of the dielectric substrate, controls the amplitudes and phases of signals for feeding the linear antenna elements on an element-by-element basis and selectively feeds the microstrip antenna element or the plurality of linear antenna elements, and can thereby realize an antenna apparatus capable of obtaining a high gain in all directions over a three-dimensional area on the surface of the dielectric substrate. Furthermore, the present invention can also realize an antenna apparatus in a small and simple configuration.

This application is based on the Japanese Patent Application No. 2003-041492 filed on Feb. 19, 2003, entire content of which is expressly incorporated by reference herein.

### INDUSTRIAL APPLICABILITY

The present invention relates to an antenna apparatus applicable to a microwave band and millimeter wave band and is suitable for use in, for example, a fixed station apparatus in a wireless LAN system.

1. An antenna apparatus comprising:
a dielectric substrate having a predetermined dielectric constant;
a microstrip antenna element placed on the surface of said dielectric substrate;
a plurality of linear antenna elements arranged radially on and perpendicular to the surface of said dielectric substrate;
a control section that controls the amplitudes and phases of signals for feeding said linear antenna elements on an element-by-element basis; and
a switchover section that selectively feeds said microstrip antenna element or said plurality of linear antenna elements.

2. The antenna apparatus according to claim 1, wherein said switchover section comprises a comparison section that compares the reception state of said plurality of linear antenna elements and the reception state of said microstrip antenna element, and
the antenna element which has received a signal whose reception state is decided to be good by said comparison section is fed.

3. The antenna apparatus according to claim 1, further comprising:
a hole provided in the center of said microstrip antenna element penetrating said microstrip antenna element and said dielectric substrate;
a column provided in said hole; and
supporting members radially spliced from said column that support said linear antenna elements.

4. The antenna apparatus according to claim 1, wherein said plurality of linear antenna elements are arranged in multiple stages in the direction perpendicular to the surface of said dielectric substrate.

5. The antenna apparatus according to claim 4, wherein said control section controls the phases of signals for feeding said plurality of multi-staged linear antenna elements on an element-by-element basis.

6. The antenna apparatus according to claim 1, wherein a plurality of said microstrip antenna elements are arranged on said dielectric substrate and said control section controls the amplitudes and phases of signals for feeding said plurality of microstrip antenna elements on an element-by-element basis.

7. The antenna apparatus according to claim 1, wherein mono-pole antennas or dipole antennas are used as said plurality of linear antenna elements.
